(19) United States
(12) Patent Application Publication
(10) Pub. No.: US 2022/0138186 A1
(43) Pub. Date: May 5, 2022

(54) DATA SET ACQUISITION METHOD, TERMINAL DEVICE AND COMPUTER READABLE STORAGE MEDIUM

(71) Applicant: SHENZHEN TINYSOFT CO., LTD., Shenzhen (CN)

(72) Inventor: Ermou LIU, Shenzhen (CN)

(21) Appl. No.: 17/436,901

(22) PCT Filed: Mar. 5, 2019
(86) PCT No.: PCT/CN2019/076989

§ 371 Date: Sep. 7, 2021

(51) Int. Cl. G06F 16/242; G06F 16/2455; G06F 9/445

(52) U.S. Cl. CPC G06F 16/244; G06F 9/44505; G06F 16/24564

(57) ABSTRACT

The present application is used in the technical field of data set acquisition, and provides a data set acquisition method, a terminal device, and a computer readable storage medium. One data set acquisition method comprises: when detecting a target command to access a target result set, on the basis of an access key word in the target command, determining a target cursor set from a cursor set of the target result set; and, on the basis of the access key word and the target cursor set, acquiring a target data set from the target result set, thereby implementing direct acquisition of a data set in a target result set, providing a basis for directly processing target data in a target result set, and increasing the efficiency of data set acquisition.

### CROSS REFERENCE TO RELATED APPLICATIONS

This application is a National Stage of PCT Application No. PCT/CN2019/076989 filed on Mar. 5, 2019, the content of which is incorporated herein by reference thereto.

### TECHNICAL FIELD

The present application relates to the technical field of data set acquisition, and particularly to a data set acquisition method, a terminal device, and a computer readable storage medium.

### BACKGROUND

With the development of science and technology, product development or market expansion in more and more fields needs to rely on collection, processing and analysis etc. of big data, at the same time, a corresponding database is required to be constructed to facilitate storage and extraction of the data. SQL (Structured Query Language) is a language for database query and programming, which is used to store and read data, and query, update and manage the database. As the most important relational database operating language, the influence of SQL has already beyond the database field, and is also valued and used in other fields. For example, data retrieval in the field of artificial intelligence requires embedding a language such as SQL or the like.

Existing databases all use the SQL language for data processing, however, after obtaining resulting sets through processing a original data set by using the SQL language, it is impossible to directly process the data in the resulting sets. For example, after the original data set is grouped by using the SQL language to obtain the grouped resulting sets, only a aggregate function is supported to be processed on the groups, but a “select” statement cannot be used to directly process the data in each of the groups in the resulting sets. For example again, regarding a query nested with multiple hierarchies, when cross-hierarchy access is performed in the “select”, methods including aliases etc. are needed to express the cross-hierarchy resulting sets, thereby there is a problem of low efficiency of data set acquisition.

### SUMMARY

Embodiments of the present application provide a data set acquisition method, a terminal device, and a computer readable storage medium, which can improve the efficiency of the data set acquisition.

A first aspect of the present application provides a data set acquisition method, which includes:

determining a target cursor set from cursor sets of the target resulting set based on an access keyword contained in the target instruction if a target instruction for accessing a target resulting set is detected;

obtaining a target data set from the target resulting set based on the access keyword and the target cursor set.

A second aspect of the present application provides a data set acquisition apparatus, which includes:

a determination unit configured to determine a target cursor set from cursor sets of the target resulting set based on an access keyword contained in the target instruction if a target instruction for accessing a target resulting set is detected;

an acquisition unit configured to obtain a target data set from the target resulting set based on the access keyword and the target cursor set.

A third aspect of the present application provides a terminal device, which includes a memory, a processor, and a computer program stored in the memory and executable on the processor, the processor, when executing the computer program, implements the method as mentioned in the above first aspect.

A fourth aspect of the present application provides a computer readable storage medium with a computer program being stored thereon, the computer program, when executed by a processor, implements the method as mentioned in the above first aspect.

In the embodiments of the present application, the target cursor set is determined from the cursor sets of the target resulting set based on the access keyword contained in the target instruction when the target instruction for accessing the target resulting set is detected, and then the target data set is obtained from the target resulting set based on the access keyword and the target cursor set, so as to realize direct acquisition of the data set in the target resulting set, which provides a basis for direct process of the target data in the target resulting set, thereby improving the efficiency of the data set acquisition.

### BRIEF DESCRIPTION OF THE DRAWINGS

FIG. 1 is a flow diagram of an implementation of a data set acquisition method provided by an embodiment of the present application.

FIG. 2 is a flow diagram of an implementation of a data set acquisition method provided by another embodiment of the present application.

FIG. 3 is a structural schematic diagram of a data set acquisition apparatus provided by an embodiment of the present application.

FIG. 4 is a schematic diagram of a terminal device provided by an embodiment of the present application.

### DETAILED DESCRIPTION

In the following description, for the purpose of illustration rather than limitation, specific details, such as a specific system structure and a specific technology, etc., are proposed for a thorough understanding of the embodiments of the present application. However, it should be understood to those skilled in the art that the present application can also be implemented in other embodiments without these specific details. In other cases, detailed descriptions of well-known systems, apparatuses, circuits, and methods are omitted to avoid unnecessary details from obstructing the description of the present application.

In order to illustrate the technical solutions of the present application, specific embodiments are illustrated below.

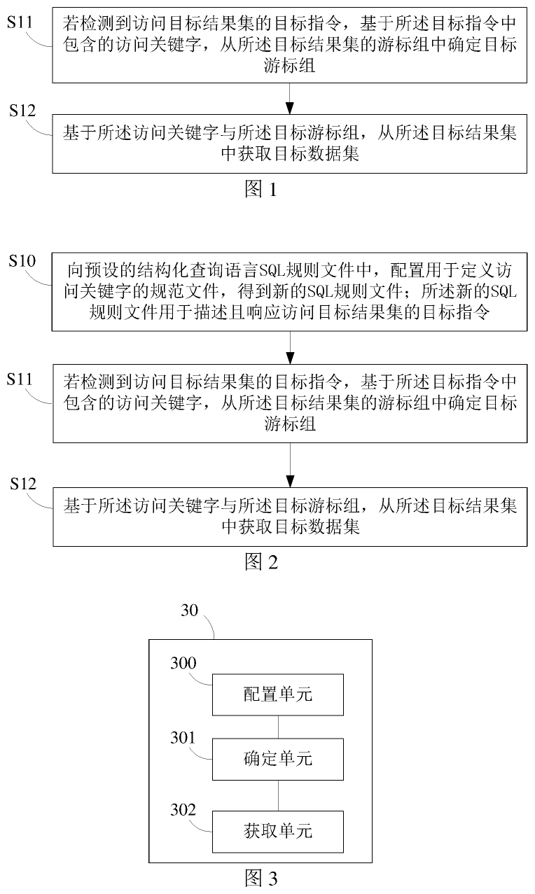

Refer to FIG. 1, FIG. 1 is a flow diagram of an implementation of a data set acquisition method provided by an embodiment of the present application. An executor of the data set acquisition method in this embodiment may be a client terminal or a server that stores the data set. Since the data set may be stored in a database or in other forms of storage space, so the specific storage manner of the data set will not be described in this embodiment again.

As shown in FIG. 1, the data set acquisition method may include following.

At S11, if a target instruction for accessing a target resulting set is detected, determine a target cursor set from cursor sets of the target resulting set based on an access keyword contained in the target instruction.

In the step S11, the data in the target resulting set has a one-to-one correspondence with cursors in the cursor sets. The cursor sets may be obtained through data storage according to a preset storage rule, or may be obtained through setting a fixed arrangement rule.

In this embodiment, the target instruction may specifically be an instruction written in an SQL language and configured for processing the data in the target resulting set, and the target instruction contains the access keyword for accessing the target resulting set.

In all the embodiments of the present application, before the target resulting set is specified, a user can input a corresponding data processing instruction to process original data set according to needs, for example, to perform grouping on the original data set, or to perform query on the original data set. The resulting sets is obtained after processing the original data set, and the target resulting set may be determined from the resulting sets according to the target instruction.

It should be noted that the time of detecting whether the target instruction is triggered may include but is not limited to the following scenarios.

For example, after processing the original data set, it is detected whether the target instruction for accessing the target resulting set is triggered.

Specifically, after the original data set is grouped or queried and the resulting sets are obtained, it is detected whether the target instruction for accessing the target resulting set is triggered; here the target instruction is configured to determine the target resulting set from the resulting sets and characterize the cursor sets in the target resulting set.

It should be understood that, in practical applications, the processed result cannot be directly further processed after the original data set is processed, for example, after the original data is processed by using a “GOUP BY” statement, the processed grouping results cannot be directly operated by using the keyword “Select”. However, in the data set acquisition method provided by this embodiment, the access keyword is configured to point to the cursor set in the target resulting set, so that when the data in the target resulting set is required to be further processed, the grouped resulting sets can be processed directly by utilizing the characteristic that the keyword points to the corresponding cursor set in the sets.

At S12, obtain a target data set from the target resulting set based on the access keyword and the target cursor set.

In the step S12, since the data in the target resulting set has a one-to-one correspondence with the cursors in the target cursor set, that is, the data in the target resulting set is correspondingly provided with one cursor.

It should be noted that the target data set is configured to characterize all the data in the target resulting set.

This embodiment of the present application determines the target cursor set from the cursor sets of the target resulting set based on the access keyword contained in the target instruction when the target instruction for accessing the target resulting set is detected, and then obtains the target data set from the target resulting set based on the access keyword and the target cursor set, so as to realize direct acquisition of the data set in the target resulting set, thereby providing a basis for directly processing the target data in the target resulting set and improving the efficiency of the data set acquisition.

Refer to FIG. 2, FIG. 2 is a flow diagram of an implementation of a data set acquisition method provided by another embodiment of the present application. The difference between this embodiment and the previous embodiment lies in that the method, before step S11, includes a step S10. specifically:

At S10, configure a specification file for defining the access keyword in a preset structured query language SQL rule file to obtain a new SQL rule file; here the new SQL rule file is configured to describe and respond to the target instruction for accessing the target resulting set.

In the step S10, the SQL rule file is configured to define a usage specification of a query statement. The specification file of the access keyword is a protocol file configured to describe a data access rule of the access keyword.

In this embodiment, in the new SQL rule file, a preset instruction for determining the target resulting set from the resulting sets is defined, and the cursor set of the target resulting set is further obtained by responding to this target instruction when the target instruction used for the target resulting set is detected.

It should be noted that in this embodiment, the new SQL rule file is obtained by configuring the specification file configured to define the access keyword into the SQL rule file, and since the new aggregate function rule file is configured to describe and respond to the target instruction used for determining the target resulting set from the resulting sets, then the target data in the target resulting set may be further obtained by responding to this target instruction when the target instruction used for the target resulting set is detected.

In all embodiments of the present application, the specification file defining the access keyword is configured in the new SQL rule file, and the specification file of the access keyword is a protocol file configured to describe an extraction rule of the access keyword.

Since the new SQL rule file is configured to describe and respond to the target instruction used for accessing the target resulting set, then the direct operation on the data in the target resulting set may be achieved by responding to the target instruction containing the access keyword when the target data in the target resulting set is required to be processed.

Further, as a possible implementation of this embodiment, the target resulting set includes two or more group data sets obtained by grouping the original data set; the access keyword is used to indicate the cursor set in the target group data set when the group data sets are traversed, and the target group data set is any group data set in the two or more group data sets. Specifically, the step S11 may include:

determining a target group data set from two or more group data sets according to the access keyword, and identifying the cursor set in the target group data set as the target cursor set.

Further, the step S12 may specifically include:

obtaining the target data set pointed by the target cursor set from the target resulting set.

In this embodiment, the access keyword is configured to indicate the cursor set in the target group data set when all the group data sets are traversed, the target group data set is any group data set of the two or more group data sets, and the cursor set in the target group data set is supported as a query object, that is, access in a FROM clause of the “SELECT” statement.

It should be noted that current SQL aggregate functions can group the original data set for statistics, but cannot perform complex processing on the content of each of the groups after grouping, and it is difficult to return the results in the groups. When this demand is encountered, the user need to use a very complex compound query to solve this problem, but the operation performance is poor and the development is extremely inconvenient.

E.g:

supposing that a score table is called ScoreTable, which contains fields of ID, Score, Lesson; if we want to count the highest score of each subject, we can use a statement like this:

“Select Lesson, Max(Score) from ScoreTable Group By Lesson”.

If we still need to know who has the highest score in each subject, although it can be achieved, it will be very complicated to write and it will be not straightforward, and the efficiency will be very low.

In this embodiment, the keywords of the grouped cursor sets are added to characterize the cursor set of the target resulting set, thereby realize the access and processing of the target resulting set. We assume that this keyword is called ThisGroup.

For example, supposing that the score table is named ScoreTable, and there is a field, i.e. class, representing the class, If you need to access the content in each of the groups when grouping the class, you can access ThisGroup with a subquery. ThisGroup represents the cursor set of each of the groups in the data resulting set.

The implementation statement is “Select Class, select * from ThisGroup from ScoreTable group by Class”. By using this mode, the groups can not only be processed by the aggregate function, but also the grouped content can be treated as a normal resulting set.

Further, as a possible implementation of this embodiment, the target resulting set is a hierarchical data set group obtained after data query performed on the original data set; the access keyword is configured to distinguish a target hierarchical data set from the hierarchical data set group, and invoke the cursor set corresponding to the target hierarchical data set. Specifically, the step S11 may include:

determining a target hierarchical data set from the hierarchical data set group according to the access keyword, and identifying the cursor set corresponding to the target hierarchical data set as the target cursor set.

In this embodiment, the target resulting set is the hierarchical data set group obtained after data query performed on the original data set; the access keyword is configured to invoke the cursor set in the target hierarchical data set, where the target hierarchical data set may be any hierarchical data set in the hierarchical data set group.

Taking the keyword RefsOf as an example, its syntax is: RefsOf(Exp,N), where Exp is used to describe the target resulting set, and N is used to specify the target hierarchy.

For example, if the resulting set of the upper hierarchy in the grouped subquery is required to be accessed to find the ID with the highest English score in each class group, we can use the following statement to achieve:

“Select Class,Max(English), (select top 1 ID from ThisGroup where English=RefsOf(Max(English),1)) from ScoreTable group by Class”.

By using RefsOf, we don't need to make any aliases for the resulting set, we can access the upper hierarchical resulting set, and can also access an upper hierarchical resulting set just above this upper hierarchical resulting set, etc., thereby this kind of access makes the data processing process more simple and convenient.

It will be understood that when the existing query statement is nested with another query statement, it is not convenient to access the resulting set of the parent query statement in the query of child query statement, and different aliases are needed for identification when there is a need to access the same data list in two query operations, which also increases the confusion of semantic understanding. In the method provided in this embodiment, through adding access keyword to invoke the cursor set in the target hierarchical data set, the resulting set of the query can be easily accessed, and the query can be achieved by using a relatively simple access keyword no matter how many hierarchies are nested in the query, thereby avoiding the confusion caused by the aliases.

As can be seen from the above, in the embodiments of the present application, the target cursor set is determined from the cursor sets of the target resulting set based on the access keyword contained in the target instruction when the target instruction for accessing the target resulting set is detected, and then the target data set is obtained from the target resulting set based on the access keyword and the target cursor set, so as to realize direct acquisition of the data set in the target resulting set, which provides a basis for direct process of the target data in the target resulting set, thereby improving the efficiency of the data set acquisition.

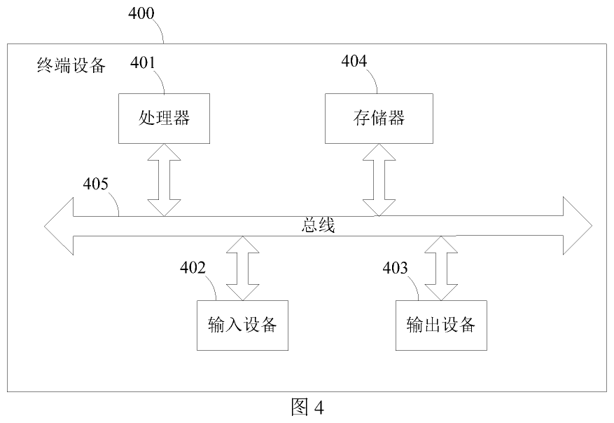

Refer to FIG. 3, FIG. 3 is a schematic diagram of a data set acquisition apparatus provided by an embodiment of the present application. The data set acquisition apparatus 30 in this embodiment includes units for executing the steps in the embodiment corresponding to FIG. 2, and details please refer to the relevant description in the embodiment corresponding to FIG. 2, which will not be repeated herein again. The data set acquisition apparatus 30 in this embodiment includes: a determination unit 301 and an acquisition unit 302. specifically:

the determination unit 301 is configured to determine a target cursor set from cursor sets of the target resulting set based on an access keyword contained in the target instruction if a target instruction for accessing a target resulting set is detected;

the acquisition unit 302 is configured to obtain a target data set from the target resulting set based on the access keyword and the target cursor set.

Further, as a possible implementation of this embodiment, the data set acquisition apparatus 30 further includes a configuration unit 300 used to configure a specification file for defining the access keyword in a preset structured query language SQL rule file to obtain a new SQL rule file; here the new SQL rule file is configured to describe and respond to the target instruction for accessing the target resulting set.

Further, as a possible implementation of this embodiment, the target resulting set includes two or more group data sets obtained by grouping the original data set; the access keyword is used to indicate the cursor set in the target group data set when the group data sets are traversed, and the target group data set is any group data set in the two or more group data sets.

The determination unit 301 is specifically configured to determine a target group data set from two or more group data sets according to the access keyword, and identify the cursor set in the target group data set as the target cursor set.

Further, as a possible implementation of this embodiment, the acquisition unit 302 is specifically configured to obtain a target data set pointed by the target cursor set from the target resulting set.

Further, as a possible implementation of this embodiment, the target resulting set is a hierarchical data set group obtained after data query performed on the original data set; the access keyword is configured to distinguish a target hierarchical data set from the hierarchical data set group, and invoke the cursor set corresponding to the target hierarchical data set. Specifically, the determination unit 301 is further configured to determine a target hierarchical data set from the hierarchical data set group according to the access keyword, and identify the cursor set corresponding to the target hierarchical data set as the target cursor set.

Refer to FIG. 4, FIG. 4 is a schematic diagram of a terminal device provided by another embodiment of the present application. The terminal device 400 in this embodiment as shown in the figure may include: one or more processors 401, one or more input devices 402, one or more output devices 403, and a memory 404. The processors 401, the input devices 402, the output devices 403, and the memory 404 are connected via a bus 405. The memory 404 is used to store a computer program including instructions, and the processors 401 performs following operations by extracting the computer program stored in the memory 404:

the processors 401 are configured to determine a target cursor set from cursor sets of the target resulting set based on an access keyword contained in the target instruction if a target instruction for accessing a target resulting set is detected;

the processors 401 are configured to obtain a target data set from the target resulting set based on the access keyword and the target cursor set.

As a possible implementation of this embodiment, the processors are further used to configure a specification file for defining the access keyword in a preset structured query language SQL rule file to obtain a new SQL rule file; here the new SQL rule file is configured to describe and respond to the target instruction for accessing the target resulting set.

As a possible implementation of this embodiment, the target resulting set includes two or more group data sets obtained by grouping the original data set; the access keyword is used to indicate the cursor set in the target group data set when the group data sets are traversed, and the target group data set is any group data set in the two or more group data sets. Specifically, the processors 401 are configured to determine a target group data set from two or more group data sets according to the access keyword, and identify the cursor set in the target group data set as the target cursor set.

As a possible implementation of this embodiment, the processors 401 are specifically configured to obtain a target data set pointed by the target cursor set from the target resulting set.

As a possible implementation of this embodiment, the target resulting set is a hierarchical data set group obtained after data query performed on the original data set; the access keyword is configured to distinguish a target hierarchical data set from the hierarchical data set group, and invoke the cursor set corresponding to the target hierarchical data set. Specifically, the processors 401 are configured to determine a target hierarchical data set from the hierarchical data set group according to the access keyword, and identify the cursor set corresponding to the target hierarchical data set as the target cursor set.

It should be understood that in the embodiments of the present application, the so-called processor 401 may be a CPU (Central Processing Unit), and the processor may also be other general-purpose processors or DSP (Digital Signal Processor), ASIC (Application Specific Integrated Circuit), FPGA (Field-Programmable Gate Array), or other programmable logic device, discrete gate or transistor logic device, discrete hardware component, etc. The general-purpose processor may be a microprocessor or the processor may also be any conventional processor or the like.

The input device 402 may include a touch panel, a fingerprint sensor (used to collect user fingerprint information and fingerprint orientation information), a microphone, etc., and the output device 403 may include a display (LCD, etc.), a speaker, and the like.

The memory 404 may include a read-only memory and a random access memory, and provide instructions and data to the processor 401. A part of the memory 404 may also include a non-volatile random access memory. For example, the memory 404 may also store information of the type of the device.

In a specific implementation, the processors 401, the input devices 402, and the output devices 403 described in the embodiments of the present application can perform the implementations described in the data set acquisition method provided by the embodiments of the present application, or the implementations of the device described in the embodiments of the present application, which will not be repeated herein again.

Another embodiment of the present application provides a computer readable storage medium, a computer program is stored in the computer readable storage medium, and the computer program, when executed by a processor, implements steps of:

determining a target cursor set from cursor sets of the target resulting set based on an access keyword contained in the target instruction if a target instruction for accessing a target resulting set is detected;

obtaining a target data set from the target resulting set based on the access keyword and the target cursor set.

As a possible implementation of this embodiment, the computer program, when executed by a processor, further implements a step of:

configuring a specification file for defining the access keyword in a preset structured query language SQL rule file to obtain a new SQL rule file; here the new SQL rule file is configured to describe and respond to the target instruction for accessing the target resulting set.

As a possible implementation of this embodiment, the target resulting set includes two or more group data sets obtained by grouping the original data set; the access keyword is used to indicate the cursor set in the target group data set when the group data sets are traversed, and the target group data set is any group data set in the two or more group data sets. The computer program, when executed by a processor, further implements a step of:

determining a target group data set from two or more group data sets according to the access keyword, and identifying the cursor set in the target group data set as the target cursor set.

As a possible implementation of this embodiment, the computer program, when executed by a processor, further implements a step of:

obtaining a target data set pointed by the target cursor set from the target resulting set.

As a possible implementation of this embodiment, the target resulting set is a hierarchical data set group obtained after data query performed on the original data set; the access keyword is configured to distinguish a target hierarchical data set from the hierarchical data set group, and invoke the cursor set corresponding to the target hierarchical data set. The computer program, when executed by a processor, further implements a step of:

determining a target hierarchical data set from the hierarchical data set group according to the access keyword, and identifying the cursor set corresponding to the target hierarchical data set as the target cursor set.

As can be seen from the above, in the embodiments of the present application, the target cursor set is determined from the cursor sets of the target resulting set based on the access keyword contained in the target instruction when the target instruction for accessing the target resulting set is detected, and then the target data set is obtained from the target resulting set based on the access keyword and the target cursor set, so as to realize direct acquisition of the data set in the target resulting set, which provides a basis for direct process of the target data in the target resulting set, thereby improving the efficiency of the data set acquisition.

The computer readable storage medium may be an internal storage unit of the device described in any of the foregoing embodiments, such as a hard disk or memory of a computer. The computer readable storage medium may also be an external storage device of the device, such as a plug-in hard disk, a SMC (Smart Media Card), a SD (Secure Digital) card, or a flash card etc. equipped on the device. Further, the computer readable storage medium may also include both an internal storage unit and an external storage device of the device. The computer readable storage medium is used to store a computer program and other programs and data required by the device. The computer readable storage medium may also be used to temporarily store data that has been output or will be output.

In addition, the functional units in the various embodiments of the present application may be integrated into one processing unit, or each unit may exist alone physically, or two or more units may be integrated into one unit. The above-mentioned integrated unit may be implemented in a form of hardware or in a form of a software functional unit.

If the integrated unit is implemented in the form of a software functional unit and sold or used as an independent product, it may be stored in a computer readable storage medium. Based on this understanding, the technical solutions of the present application, or the part of the technical solutions of the present application that contributes to the prior art, or all or part of the technical solutions may essentially be embodied in the form of a software product, and the computer software product is stored in a storage medium, and includes several instructions to make a computer device (which may be a personal computer, a server, or a network device, etc.) execute all or part of the steps of the method described in the various embodiments of the present application. The aforementioned storage medium includes various media that can store program codes such as a U disk, a mobile hard disk, a ROM (Read-Only Memory), a RAM (Random Access Memory), a magnetic disk, or an optical disk etc.

As mentioned above, the above embodiments are only used to illustrate, but not to limit, the technical solutions of the present application. Although the present application has been described in detail with reference to the foregoing embodiments, those of ordinary skill in the art should understand that: the technical solutions recorded in the foregoing embodiments may still be modified, or some of the technical features therein may be equivalently replaced; and these modifications or replacements do not cause the essence of the corresponding technical solutions to deviate from the spirit and scope of the technical solutions of the embodiments of the present application.

1. A data set acquisition method, comprising:
determining a target cursor set from cursor sets of the target resulting set based on an access keyword contained in the target instruction if a target instruction for accessing a target resulting set is detected;
obtaining a target data set from the target resulting set based on the access keyword and the target cursor set.

2. The data set acquisition method of claim 1, wherein, before determining the target cursor set from cursor sets of the target resulting set based on the access keyword contained in the target instruction if the target instruction for accessing the target resulting set is detected, the method further comprises:
configuring a specification file for defining the access keyword in a preset structured query language SQL rule file to obtain a new SQL rule file; wherein the new SQL rule file is configured to describe and respond to the target instruction for accessing the target resulting set.

3. The data set acquisition method of claim 1, wherein, the target resulting set comprises two or more group data sets obtained by grouping an original data set; the access keyword is used to indicate the cursor set in a target group data set when the group data sets are traversed;
the determining the target cursor set from cursor sets of the target resulting set based on an access keyword contained in the target instruction comprises:
determining the target group data set from the two or more group data sets according to the access keyword, and identifying the cursor set in the target group data set as the target cursor set.

4. The data set acquisition method of claim 3, wherein, the obtaining the target data set from the target resulting set based on the access keyword and the target cursor set comprises:
obtaining a target data set pointed by the target cursor set from the target resulting set.

5. The data set acquisition method of claim 1, wherein, the target resulting set is a hierarchical data set group obtained after a data query performed on an original data set; the access keyword is configured to distinguish a target hierarchical data set from the hierarchical data set group, and invoke the cursor set corresponding to the target hierarchical data set;
the determining the target cursor set from cursor sets of the target resulting set based on an access keyword contained in the target instruction comprises:
determining the target hierarchical data set from the hierarchical data set group according to the access keyword, and identifying the cursor set corresponding to the target hierarchical data set as the target cursor set.

6. A data set acquisition apparatus, comprising:
a determination unit configured to determine a target cursor set from cursor sets of the target resulting set based on an access keyword contained in the target instruction if a target instruction for accessing a target resulting set is detected;
an acquisition unit configured to obtain a target data set from the target resulting set based on the access keyword and the target cursor set.

7. The data set acquisition apparatus of claim 6, wherein the apparatus further comprises:
a configuration unit used to configure a specification file for defining the access keyword in a preset structured query language SQL rule file to obtain a new SQL rule file; wherein the new SQL rule file is configured to describe and respond to the target instruction for accessing the target resulting set.

8. The data set acquisition apparatus of claim 6, wherein, the target resulting set comprises two or more group data sets obtained by grouping an original data set; the access keyword is used to indicate the cursor set in a target group data set, and the target group data set is any group data set in the two or more group data sets;
the determination unit is specifically configured to determine the target group data set from the two or more group data sets according to the access keyword, and identify the cursor set in the target group data set as the target cursor set.

9. A terminal device, comprising a memory, a processor, and a computer program stored in the memory and executable on the processor, characterized in that, the processor, when executing the computer program, implements steps of:
determining a target cursor set from cursor sets of the target resulting set based on an access keyword contained in the target instruction if a target instruction for accessing a target resulting set is detected;
obtaining a target data set from the target resulting set based on the access keyword and the target cursor set.

10. (canceled)

11. The terminal device of claim 9, wherein the processor, when executing the computer program, further implements a step of:
configuring a specification file for defining the access keyword in a preset structured query language SQL rule file to obtain a new SQL rule file; wherein the new SQL rule file is configured to describe and respond to the target instruction for accessing the target resulting set.

12. The terminal device of claim 9, wherein the target resulting set comprises two or more group data sets obtained by grouping an original data set; the access keyword is used to indicate the cursor set in a target group data set when the group data sets are traversed; wherein the processor, when executing the computer program, further implements a step of:
determining the target group data set from the two or more group data sets according to the access keyword, and identifying the cursor set in the target group data set as the target cursor set.

13. The terminal device of claim 12, wherein the processor, when executing the computer program, further implements a step of:
obtaining a target data set pointed by the target cursor set from the target resulting set.

14. The terminal device of claim 9, wherein the target resulting set is a hierarchical data set group obtained after a data query performed on an original data set; the access keyword is configured to distinguish a target hierarchical data set from the hierarchical data set group, and invoke the cursor set corresponding to the target hierarchical data set; wherein the processor, when executing the computer program, further implements a step of:
determining the target hierarchical data set from the hierarchical data set group according to the access keyword, and identifying the cursor set corresponding to the target hierarchical data set as the target cursor set.
